(19) United States
(12) Patent Application Publication
(10) Pub. No.: US 2026/0110202 A1
(43) Pub. Date: Apr. 23, 2026

(54) DOCKING APPARATUS

(71) Applicants: Hyundai Motor Company, Seoul (KR); Kia Corporation, Seoul (KR); EXA Electronics Co., Ltd., Hwaseong-si (KR)

(72) Inventors: Jin Ho HWANG, Hwaseong-Si (KR); Jae Seung LEE, Hwaseong-Si (KR); Sang Heon LEE, Hwaseong-Si (KR); Choon Taik KIM, Yongin-Si (KR)

(73) Assignees: Hyundai Motor Company, Seoul (KR); Kia Corporation, Seoul (KR); EXA Electronics Co., Ltd., Hwaseong-si (KR)

(21) Appl. No.: 19/193,753

(22) Filed: Apr. 29, 2025

(30) Foreign Application Priority Data
Oct. 18, 2024 (KR) 10-2024-0143083

(51) Int. Cl. E05C 19/16; B60J 7/10

(52) U.S. Cl. CPC E05C 19/163; B60J 7/106

(57) ABSTRACT

Upon docking between different parts, a docking system maintains a strong docking state in accordance with linkage of locking according to magnetism and locking according to mechanical connection. The docking system also prevents generation of gaps in various directions including upward, downward, left and right directions in the docking state, thereby being capable of securing durability and quality of each portion.

### CROSS-REFERENCE TO RELATED APPLICATION

The present application claims priority to Korean Patent Application No. 10-2024-0143083 filed on Oct. 18, 2024, the entire contents of which is incorporated herein for all purposes by this reference.

### BACKGROUND OF THE PRESENT DISCLOSURE

### Field of the Present Disclosure

The present disclosure relates to a docking apparatus configured to maintain a firm connection state of different parts when the parts dock with each other.

### Description of Related Art

Recently, interest in autonomous mobile apparatuses has increased. Such an autonomous mobile apparatus is an apparatus to which autonomous driving technology is applied so that the apparatus is autonomously driven even when a user or a passenger does not perform direct manipulation as to whether the apparatus should move, and a movement direction, a movement speed, etc. of the apparatus. For example, an autonomous vehicle, an autonomous robot, a robot cleaner, etc. may be examples of the autonomous mobile apparatus. The autonomous mobile apparatus may be diversely used in accordance with use purposes thereof.

As use purposes of the autonomous mobile apparatus are diverse as mentioned above, a docking system between autonomous mobile apparatuses is being developed.

For example, a plurality of autonomous mobile apparatuses respectively configured to provide individual internal compartments may dock with one another through a docking system to increase an internal compartment as a whole.

In another example, when a vehicle is manufactured, different parts thereof may be coupled to each other through a docking system, and accordingly, convenience of coupling may be secured. Furthermore, such different parts may be coupled to each other through a docking system after being separately manufactured, for various use purposes thereof. In in accordance with use purposes, the different parts may also be replaceable.

When a plurality of parts, for example, modules, is assembled, it is necessary not only to secure convenience of assembly, but also to assemble the modules with strong fastening force. When assembly fastening is degraded, assembly of the modules may be released due to a gap generated between the modules or separation of the modules from each other.

Furthermore, in an assembly type mobile apparatus, easy management of each module thereof should be secured taking into consideration not only an assembly procedure, but also a separation procedure.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a docking system configured for maintaining a strong docking state of different parts through coupling according to magnetic force and coupling according to mechanical connection when the different parts dock with each other by the docking system, and preventing generation of a gap between the different parts in various directions including upward, downward, left and right directions in the docking state.

Objects of the present disclosure are not limited to the above-described object, and other objects of the present disclosure not yet described will be more clearly understood by those skilled in the art from the following detailed description.

In accordance with an aspect of the present disclosure, the above and other objects may be accomplished by the provision of a docking system including a first part including a body and a driver, the body being provided with a magnetic member formed of a magnetic material to be magnetized by the magnetic member and including an opening extending in one direction, and the driver including a locker configured to vary a rotation direction thereof and disposed at the opening, and a second part including a holder inserted into the opening of the first part while extending toward the opening and being configured to receive the locker, the second part being joined to the first part by magnetic force when the second part comes into contact with the first part, and the locker being engaged with the holder in accordance with the rotation direction of the locker according to operation of the driver so that the locker is locked by the holder.

In accordance with an exemplary embodiment of the present disclosure, the body may include a first portion made of a magnetic material, and a second portion made of a non-magnetic material. The opening may be formed at the first portion. The driver may be provided at the second portion, and the locker of the driver is disposed at the opening while extending through the first portion and the second portion.

In accordance with an exemplary embodiment of the present disclosure, an installation portion may be formed at an inside of the first portion to communicate with the opening, and the magnetic member may be provided at the installation portion.

In accordance with an exemplary embodiment of the present disclosure, the first portion may be provided at a center portion of the body. The second portion may include two second portions coupled to opposite sides of the first portion, respectively so that the driver is provided at one of the two second portions. The locker extending from the driver may be rotatably supported by the other of the two second portions.

In accordance with an exemplary embodiment of the present disclosure, the holder may be formed with a groove configured to receive the locker and engagement jaws may be formed at the groove so that the locker is engaged with the engagement jaws in accordance with a rotation direction of the locker, to be locked.

In accordance with an exemplary embodiment of the present disclosure, the groove may be formed at a center portion of the holder, and the engagement jaws may be formed to be symmetrical with each other with reference to a center portion of the groove.

In accordance with an exemplary embodiment of the present disclosure, a cross-section of the locker in a direction in which the first part and the second part come into contact with each other may have an oval shape. The holder may be formed so that a portion of the groove, at which the engagement jaws are formed, has an internal diameter greater than or equal to a length of a shorter width portion of the oval shape of the locker, and an internal end portion of the groove may be formed to have a shape of a circle including an internal diameter greater than a length of a longer width portion of the oval shape of the locker.

In accordance with an exemplary embodiment of the present disclosure, the locker may be formed so that a cross-section thereof in a direction in which the first part and the second part come into contact with each other has a shape of a circle, and may be formed with at least one jaw at a periphery thereof.

In accordance with an exemplary embodiment of the present disclosure, the jaw may be formed in plural at the periphery of the locker about a center portion of the cross-section of the locker so that the plurality of jaws is asymmetrically disposed with reference to the center portion of the cross-section. The engagement jaw may be formed in plural so that the plurality of engagement jaws is asymmetrically disposed with reference to an insertion direction of the locker while protruding.

In accordance with an exemplary embodiment of the present disclosure, the locker may include a rotation member coupled to the driver and configured to be rotated by the driver, and an engagement member configured to be deformed by the rotation member in accordance with rotation of the rotation member, being selectively engaged with the engagement jaws.

In accordance with an exemplary embodiment of the present disclosure, the rotation member may have a cross-section having a non-circular shape or a polygonal shape. The engagement member may have including a pair of hooks rotatably connected to each other. The rotation member may be disposed between the pair of hooks to diverge or converge the pair of hooks in accordance with a rotation direction of the rotation member, causing the pair of hooks to be selectively engaged with the engagement jaws.

In accordance with an exemplary embodiment of the present disclosure, the magnetic member may include a first magnet and a second magnet. The first magnet may be connected to the driver within the body so that the first magnet is rotatable, and the second magnet may be fixed within the body while being spaced apart from the first magnet.

In accordance with an exemplary embodiment of the present disclosure, each of the first magnet and the second magnet may include a permanent magnet so that a direction of magnetic field lines flowing through the body is varied in accordance with a rotation direction of the first magnet.

In accordance with an exemplary embodiment of the present disclosure, the second part may further include a joint from which the holder extends. The joint may be made of a magnetic material and may be formed to enable the body of the first part to be joined thereto. The holder may be formed to extend from the joint so that the holder is inserted into the opening.

In accordance with an exemplary embodiment of the present disclosure, the holder may have a width gradually decreasing as the holder extends toward the first part so that an external surface thereof is formed to be inclined.

In accordance with an exemplary embodiment of the present disclosure, the first part may further include a damper disposed around the body.

In accordance with an exemplary embodiment of the present disclosure, the docking system may further include a guide spaced apart from the first part, and an inserter spaced apart from the second part. The guide and the inserter may be configured so that the inserter is insertable into the guide in a direction in which the first part and the second part come into contact with each other.

In accordance with the docking system of the present disclosure, when different parts dock with each other, a strong docking state may be maintained in accordance with linkage of locking according to magnetism and locking according to mechanical connection. Furthermore, generation of gaps in various directions including upward, downward, left and right directions may be prevented in the docking state, and accordingly, durability and quality of each portion may be secured.

Effects attainable in the present disclosure are not limited to the above-described effects, and other effects of the present disclosure not yet described will be more clearly understood by those skilled in the art from the following detailed description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing application of a part and a counterpart according to an exemplary embodiment of the present disclosure;

FIG. 2 is an enlarged view of an area A in FIG. 1;

FIG. 3 is an enlarged view of an area B in FIG. 1;

FIG. 4 is a view showing a docking state between a part and a counterpart in a docking apparatus according to an exemplary embodiment of the present disclosure;

FIG. 5 is a view showing a docking release state between the part and the counterpart in the docking apparatus according to the embodiment;

FIG. 6 is a view showing the docking release state between the part and the counterpart in the docking apparatus according to the embodiment;

FIG. 7 is a top view of the counterpart in the docking apparatus according to the embodiment;

FIG. 8 is a view showing an exemplary embodiment of a locker and a holder in the docking apparatus according to the embodiment;

FIG. 9 is a view showing another exemplary embodiment of a locker and a holder in the docking apparatus according to the embodiment;

FIG. 10 is a view showing another exemplary embodiment of a locker and a holder in the docking apparatus according to the embodiment;

FIG. 11 is a cross-sectional view showing a docking state between the part and the counterpart in the docking apparatus according to the embodiment;

FIG. 12 is a view showing a driver according to an exemplary embodiment of the present disclosure; and

FIG. 13 is a view showing a guide and an inserter according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In the following description of the exemplary embodiments of the present disclosure, a detailed description of known technologies incorporated herein will be omitted when it may obscure the subject matter of the exemplary embodiments of the present disclosure. Furthermore, the exemplary embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure. The following description is not intended to limit the present disclosure to the precise forms or particular fields of use disclosed. Accordingly, it is contemplated that various alternate embodiments and/or modifications to the present disclosure, whether explicitly described or implied herein, are possible in light of the present disclosure. A person of ordinary skill in the art will recognize that changes may be made in form and detail without departing from the scope of the present disclosure.

The present disclosure will be described with reference to specific embodiments. However, as one skilled in the art will appreciate, various embodiments disclosed herein can be modified or otherwise implemented in various other ways without departing from the spirit and scope of the present disclosure. Accordingly, the following description is to be considered as illustrative and is for teaching those skilled in the art the manner of making and using various embodiments. It is to be understood that the forms of disclosure herein shown and described are to be taken as representative embodiments. Equivalent elements, materials, processes or steps may be substituted for those representatively illustrated and described herein. Expressions such as “including”, “comprising”, “incorporating”, “consisting of”, “have”, “is” used to describe the present disclosure are intended to be construed in a non-exclusive manner, namely, in a manner allowing items, components or elements not explicitly described also to be present. Unless clearly used otherwise, singular expressions should be interpreted as including a plural meaning.

Furthermore, various embodiments included herein are to be taken in the illustrative and explanatory sense, and should in no way be construed as limiting of the present disclosure. All references as to joining (e.g., attached, affixed, coupled, connected, and the like) are only used to aid understanding of the present disclosure, and may not create limitations, particularly as to the position, orientation, or use of the configuration or the method included herein. Therefore, references as to joining, if any, are to be construed broadly. Moreover, such references as to joining do not necessarily infer that two elements are directly connected to each other. Additionally, all numerical terms, such as, but not limited to, “first”, “second”, “third”, “primary”, “secondary”, “main” or any other ordinal or numerical terms, should also be taken only as identifiers, to assist understanding of various elements, embodiments, variations or modifications of the present disclosure, and may not mean any limitation as to embodiment, variation or modification of any element or any limitation as to the order or preference thereof. That is, although such expressions may be used to describe various constituent elements, these constituent elements are not limited by the expressions associated therewith. Such expression is used only for distinguishment of one constituent element from another constituent element.

The suffixes “module” and “unit” of elements herein are used for convenience of description and thus may be used interchangeably and do not have any distinguishable meanings or functions.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

A controller may include a communication device configured to communicate with another controller or a sensor, for control of a function to be performed accordingly, a memory configured to store an operating system, logic commands, input/output information, etc., and at least one processor, etc. configured to execute discrimination, calculation, determination, etc. required for control of the function to be performed.

Any number of components or a variety of components of any one of the configurations disclosed in the present disclosure may be included in the present disclosure. Such components may include any combination of characterized portions disclosed in the present disclosure, and may be arranged to constitute any one of various configurations disclosed in the present disclosure. Not only structures and arrangements of the components of the present disclosure, but also concepts as to use and operation thereof, may be applied not only to particular embodiments discussed in the present disclosure, but also to embodiments of any numbers and in any combinations. In the following description, various exemplary embodiments including various characterized portions including various arrangements will be described with reference to the accompanying drawings.

Hereinafter, various embodiments included in the present disclosure will be described in detail with reference to the accompanying drawings, and the same or similar elements are designated by the same reference numerals regardless of the numerals in the drawings and redundant description thereof will be omitted.

The present disclosure relates to a docking apparatus configured to assemble different parts P1 or to separate the assembled parts P1 from each other.

That is, the docking apparatus according to an exemplary embodiment of the present disclosure may be used to dock different mobile apparatuses to each other, to configure a driving portion and a compartment-providing portion configured to provide an internal compartment so that the driving portion and the compartment-providing portion are separably coupled to a customizable vehicle after being separately manufactured, or to selectively mount or separate a plurality of parts P1 in accordance with various use purposes or situations such as connection between a building and a vehicle, connection between buildings, etc. The docking apparatus for the present disclosure may be diversely used in accordance with application purposes and application fields.

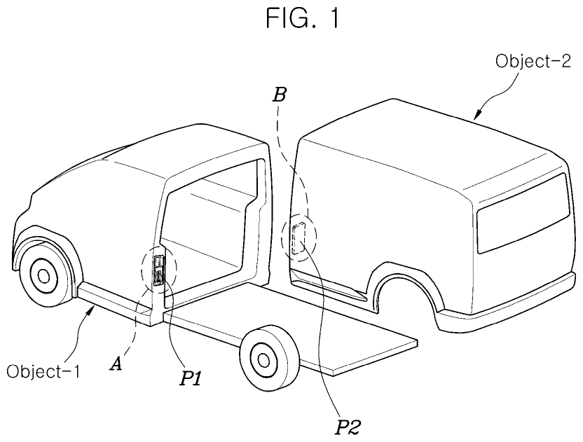

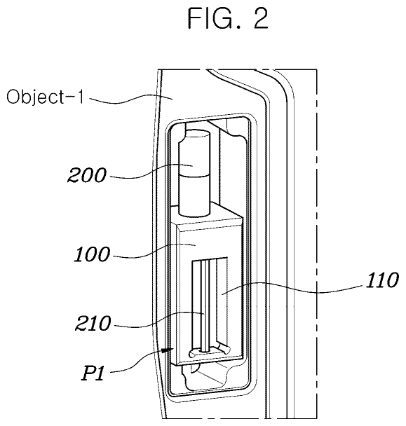

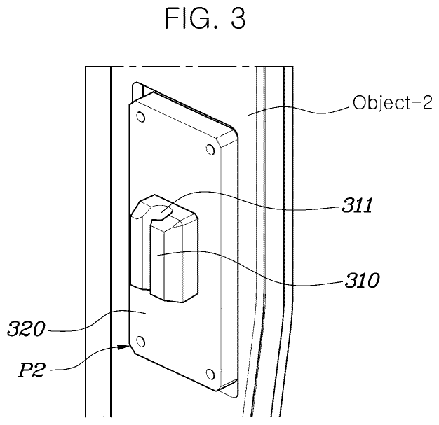

As shown in FIGS. 1 to 6, the docking apparatus according to an exemplary embodiment of the present disclosure includes a part P1 including a body 100 and a driver 200. The body 100 is provided with a magnetic member 400, is formed of a magnetic material to be magnetized by the magnetic member 400, and is formed with an opening 110 extending in one direction of the body 100.

The driver 200 includes a locker 210 configured to vary a rotation direction thereof and disposed at the opening 110. The docking apparatus according to an exemplary embodiment of the present disclosure also includes a counterpart P2 including a holder 310 inserted into the opening 110 of the part P1 while extending toward the opening 110.

The holder 310 is configured to receive the locker 210. The counterpart P2 is joined to the part P1 by magnetic force when the counterpart P2 comes into contact with the part P1, and the locker 210 is engaged with the holder 310 in accordance with a rotation direction of the locker 210 according to operation of the driver 200 so that the locker 210 is locked by the holder 310.

In an exemplary embodiment of the present disclosure, the part P1 and the counterpart P2 dock with each other, and may be provided at different objects, respectively.

For example, as shown in FIG. 1, in a structure in which a body frame and an upper body of a vehicle are joined to each other, the part P1 may be provided at the body frame, and the counterpart P2 may be provided at the upper body of the structure, and, accordingly, the upper body may be coupled to the body frame of the structure through docking between the part P1 and the counterpart P2.

Furthermore, the part P1 may be provided at an object configured to receive electric power in accordance with selective execution of docking and docking release operations through the driver 200 which will be described later. The counterpart P2 may maintain a docking state by the part P1, and may be applied to any object.

The application embodiment of the part P1 and the counterpart P2 is only one of various exemplary embodiments of the present disclosure, and the part P1 and the counterpart P2 may be diversely applied to the fields in which two objects selectively dock with each other, in addition to coupling between the body frame and the upper body.

Furthermore, each of the part P1 and the counterpart P2 may be configured in plural to increase coupling force in docking.

In an exemplary embodiment of the present disclosure, the part P1 includes the body 100 and the driver 200.

The body 100 may be made of a magnetic material, and may be provided with the magnetic member 400 therein, and accordingly, may be magnetized. In an exemplary embodiment according to a method of manufacturing the body 100 so that the body 100 has magnetism, metal powder forming a magnetic material is produced and then mixed, the mixed powder is compressively molded to form the body 100, and the compressively molded body 100 is subjected to thermal treatment to have enhanced molding density and characteristics. In the instant case, as the metal powder for manufacture of the body 100, Si-Fe alloy powder may be used. Accordingly, it may be possible to produce a magnetic material under the condition that no rare earth elements are included in the magnetic material, and accordingly, a magnetic material capable of enhancing magnetic force while having corrosion resistance may be produced. Accordingly, a magnetic material exhibiting an enhancement in magnetic characteristics such as coercivity or the like without damage to corrosion resistance thereof may be produced.

The exemplary embodiment according to manufacture of the body 100 explains only one of various exemplary embodiments of the present disclosure, and the present disclosure is not limited thereto.

The driver 200 may be electronically controlled through a controller, and may be driven by electric power supplied thereto. The controller may be a controller mounted in the driver 200 or provided at an object at which the part P1 is provided.

The driver 200 described above includes the locker 210 configured to vary a rotation direction thereof. The locker 210 may be disposed at the opening 110 formed at the body 100.

Meanwhile, the counterpart P2 includes the holder 310 inserted into the opening 110 of the part P1 while extending toward the opening 110. The holder 310 is configured to receive the locker 210 when the part P1 and the counterpart P2 move in docking directions thereof, respectively. That is, the locker 210 is configured to be rotated by the driver 200 and to be inserted into the holder 310 or to be engaged with the holder 310 in accordance with a rotation direction of the locker 210. Accordingly, the locker 210 may be mechanically locked to or released from the holder 310.

In detail, the holder 310 is formed with a groove 311 into which the locker 210 may be selectively inserted. An engagement jaw 312 is formed at a part of the groove 311. Accordingly, the locker 210 may be engaged with the engagement jaw 312 in accordance with a rotation direction of the locker 210, and accordingly, may be locked into the groove 311.

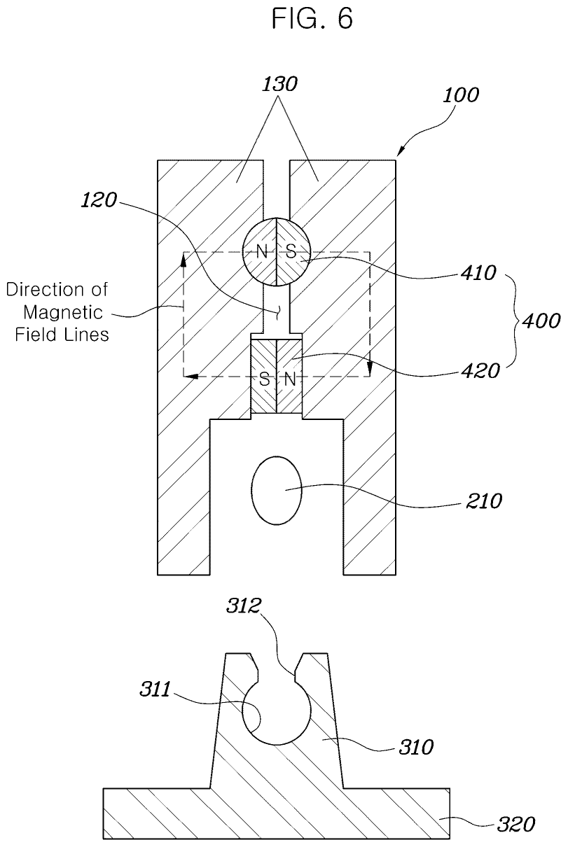

Referring to FIG. 6, the holder 310 may be recessed at an end portion thereof to form the groove 311, and the locker 210 may be in a shape of a bar extending from the driver 200 to be inserted into the groove 311. Since the engagement jaw 312 protrudes from an internal surface of the groove 311, the locker 210 may be allowed to pass the engagement jaw 312 or may be engaged with the engagement jaw 312 in accordance with a rotation direction of the locker 210. When the locker 210 is engaged with the engagement jaw 312, the locker 210 is locked. For the present function, the locker 210 may be formed to have various shapes such as a semicircular shape, an oval shape, a polygonal shape, etc., except for a circular shape, and, accordingly, the locker 210 may be inserted into the groove 311 of the holder 310 while passing the engagement jaw 312 or may be prevented from being inserted into the groove 311 by the engagement jaw 312 in accordance with a rotation direction of the locker 210.

Thus, in an exemplary embodiment of the present disclosure, the part P1 and the counterpart P2 are magnetically joined to each other when the part P1 and the counterpart P2 come into contact with each other in accordance with respective movements thereof in the docking directions thereof. Furthermore, in a state in which the locker 210 provided at the body 100 is inserted into the holder 310 of the counterpart P2, the rotation direction of the locker 210 is varied in accordance with operation of the driver 200 so that the locker 210 is engaged with the holder 310, and as such the locker 210 is mechanically locked to the groove 311 of the counterpart P2.

As described above, in an exemplary embodiment of the present disclosure, when the part P1 and the counterpart P2 dock with each other, magnetic locking and mechanical locking are simultaneously conducted, and accordingly, an enhancement in coupling force and stability in docking state between the part P1 and the counterpart P2 may be achieved.

Hereinafter, the present disclosure described above will be described in detail.

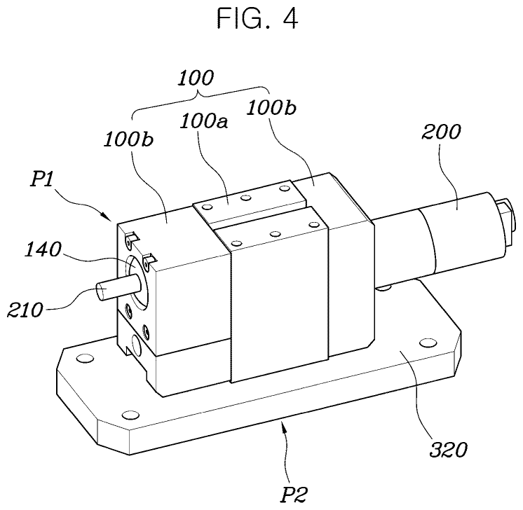

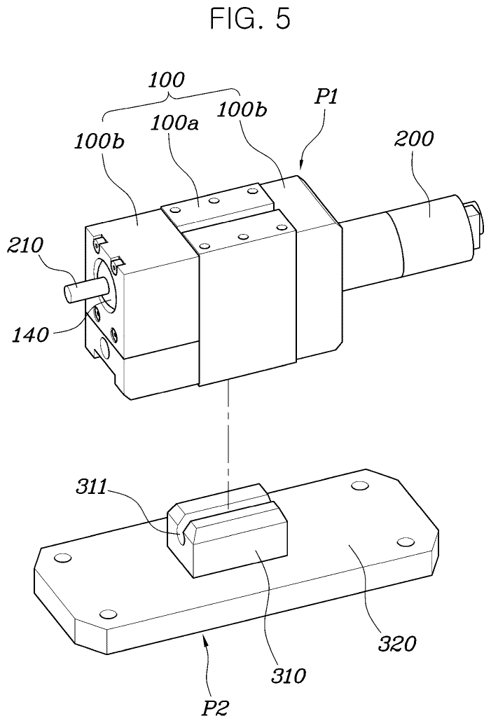

As shown in FIG. 4 and FIG. 5, the body 100 may include a first portion 100a made of a magnetic material, and a second portion 100b made of a non-magnetic material. The opening 110 may be formed at the first portion 100a, and the driver 200 may be provided at the second portion 100b. The locker 210 of the driver 200 may be disposed at the opening 110 while extending through the first portion 100a and the second portion 100b.

The first portion 100a may include a metal material, and the second portion 100b may be configured using a plastic material. Accordingly, the body 100 may be formed by separately manufacturing the first portion 100a of the magnetic material and the second portion 100b of the non-magnetic material, and then coupling the first portion 100a and the second portion 100b to each other. In accordance with such a structure, the body 100 may not only achieve lightness and a reduction in manufacturing costs, but also may secure durability and noise, vibration and harshness (NVH) performance.

The first portion 100a of the part P1, which is a portion to be joined to the counterpart P2, may be formed with the opening 110. At the second portion 100b, which is injection-molded using a non-magnetic material, the driver 200 is provided, and accordingly, installation of the driver 200 at the second portion 100b may be optimally achieved.

Furthermore, in a state in which driver 200 is provided at the second portion 100b, the locker 210 may be disposed to extend through the first portion 100a and the second portion 100b so that the locker 210 passes through the opening 110 of the first portion 100a. Accordingly, the first portion 100a and the second portion 100b may be formed with holes to allow the locker 210 of the driver 200 to pass therethrough. Even in a state in which the driver 200 is provided at the second portion 100b, the locker 210 may be disposed at the opening 110 of the first portion 100a, and accordingly, may be connected to the holder 310 of the counterpart P2.

In an exemplary embodiment of the present disclosure, one first portion 100a may be provided at a center portion of the body 100, and two second portions 100b may be coupled to opposite sides of the first portion 100a, respectively. In the instant case, the driver 200 may be provided at one of the second portions 100b, and the locker 210 extending from the driver 200 may be rotatably supported by the other of the second portions 100b.

As shown in FIG. 4, magnetic force generated by the magnetic member 400 may be prevented from influencing other elements of the part P1 by the opposite second portions 100b. Furthermore, the first portion 100a may be protected by the second portions 100b, and accordingly, damage thereto and application of impact thereto may be prevented.

In the instant case, the driver 200 is provided at one second portion 100b, and the locker 210 extending from the driver 200 is rotatably supported by the other second portion 100b. That is, the one second portion 100b may be molded to enable the driver 200 to be firmly provided thereto, and a bearing 140 may be provided at the other second portion 100b to enable the locker 210 extending from the driver 200 to be rotatably supported by the bearing 140. The bearing 140 may employ a bearing structure configured for rotatably supporting the locker 210.

In accordance with the above-described configuration, the body 100 may be configured through assembly of the first portion 100a and the second portions 100b disposed in series, and the locker 210 extends linearly through the first portion 100a and the second portions 100b in a state in which the driver 200 is connected to the second portions 100b. Accordingly, convenience of assembly of the portions of the body 100 and the driver 200 may be secured, and the resultant assembly may be structurally stabilized.

Meanwhile, an installation portion 120 (FIG. 6) may be formed at an inside of the first portion 100a to communicate with the opening 110. The magnetic member 400 may be provided at the installation portion 120.

As the opening 110 is formed at the first portion 100a of the body 100, and the installation portion 120 is formed at an inside of the opening 110, the magnetic member 400 may be provided at the installation portion 120.

In detail, as shown in FIG. 6, the first portion 100a of the body 100 may include a pair of pole members 130. In the instant case, a space between the pole members 130 may be the installation portion 120, and a space defined between end portions of respective pole members 130 may become the opening 110. In the instant case, the pole members 130 may be interconnected by the magnetic member 400 provided at the installation portion 120, and may be magnetized by the magnetic member 400. Through such a configuration, the body 100 may be magnetically joined to the counterpart P2 as the first portion 100a is magnetized by the magnetic member 400. Magnetic joining between the part P1 and the counterpart P2 by the magnetic member 400 will be described in detail later.

Meanwhile, various implementation embodiments may be applied to the locker 210 provided at the part P1 and the holder 310 provided at the counterpart P2 in an exemplary embodiment of the present disclosure.

A groove 311 may be formed at a center portion of the holder 310 so that the groove 311 is open in a direction in which the counterpart P2 faces the part P1. Engagement jaws 312 may be formed to be symmetrical with each other with reference to a center portion of the groove 311.

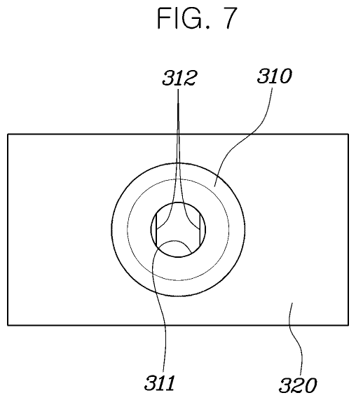

FIG. 7 is a view of the holder 310 of the counterpart P2 viewed from a top side thereof. Referring to FIG. 6, the viewing direction may be a direction in which the part P1 faces the counterpart P2.

As the groove 311 is disposed at the center portion of the holder 310, and the engagement jaws 312 are symmetrically formed at an internal surface of the groove 311, stiffness of the holder 310 may be secured in a balanced state. Furthermore, when the locker 210 is locked by the engagement jaws 312 after being inserted into the groove 311 of the holder 310, locking of the locker 210 may be maintained, and tolerance of the locker 210 may be absorbed.

Meanwhile, in an exemplary embodiment of the present disclosure, the cross-section of the locker 210 in a direction in which the part P1 and the counterpart P2 come into contact with each other may have an oval shape. Furthermore, the holder 310 may be formed so that a portion of the groove 311, at which the engagement jaws 312 are formed, has an internal diameter greater than or equal to the length of a shorter width portion of the oval shape of the locker 210, and an internal end portion of the groove 311 is formed to have a circular shape having an internal diameter greater than the length of a longer width portion of the oval shape of the locker 210.

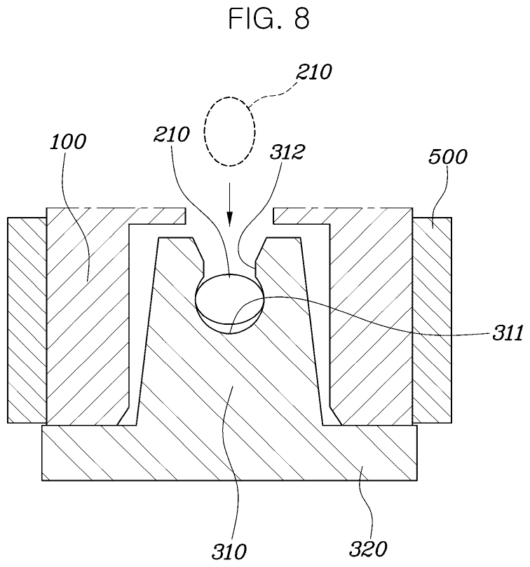

As shown in FIG. 8, the cross-section of the locker 210 may be formed to have an oval shape. Referring to FIG. 8, in a state before the locker 210 is inserted into the groove 311 of the holder 310, the horizontal direction may correspond to the shorter width portion of the locker 210, and the vertical direction may correspond to the longer width portion of the locker 210.

Accordingly, when the locker 210 is rotated to be erected by the driver 200 with reference to FIG. 8, the locker 210 may be inserted into the groove 311 of the holder 310. When the locker 210 is rotated to be reclined in the above-described state, the locker 210 may be engaged with the engagement jaws 312 within the groove 311 of the holder 310.

That is, in accordance with the oval shape of the locker 210, the portion of the groove 311, at which the engagement jaws 312 are formed, may be formed to have an internal diameter greater than or equal to the length of the shorter width portion of the oval shape of the locker 210, and, accordingly, the locker 210 may be allowed to be inserted into the groove 311 after passing the engagement jaws 312 in an erected state thereof.

Furthermore, the internal end portion of the groove 311 in an insertion direction of the locker 210 may be formed to have a circular shape having an internal diameter greater than the length of the longer width portion of the oval shape of the locker 210. Accordingly, the groove 311 may secure a space configured for allowing the locker 210 to vary a rotation direction thereof in a state in which the locker 210 is inserted into the groove 311 to reach the internal end portion of the groove 311. Accordingly, when the part P1 moves to dock with the counterpart P2, the locker 210 of the part P1 may be inserted into the groove 311 formed at the holder 310 of the counterpart P2 in a state in which the locker 210 has been adjusted to be erected by the driver 200. When the locker 210 has been inserted into the groove 311 to reach an internal end portion of the groove 311, the locker 210 is rotated to be reclined by the driver 200, and accordingly, may be engaged with the engagement jaws 312. Thus, the part P1 and the counterpart P2 may be maintained in a locked state through mechanical connection by the locker 210 and the holder 310.

Meanwhile, in another exemplary embodiment of the present disclosure, the locker 210 may be formed so that the cross-section thereof in a direction in which the part P1 and the counterpart P2 come into contact with each other has a circular shape, and may be formed with at least one jaw 211 at a periphery thereof.

That is, the locker 210 may include a structure in which the jaw 211 is formed at a portion of the circular cross-section of the locker 210 in the direction in which the part P1 and the counterpart P2 come into contact with each other. In in accordance with the present structure, when the jaw 211 faces or opposes the groove 311 of the holder 310 as the rotation direction of the locker 210 is adjusted by the driver 200, the locker 210 may pass the engagement jaw 312 of the groove 311. When the locker 210 is rotated by the driver 200 in a state of being inserted into the groove 311 to reach the internal end portion of the groove 311, the jaw 211 may be engaged with the engagement jaw 312 of the groove 311, and accordingly, may be locked.

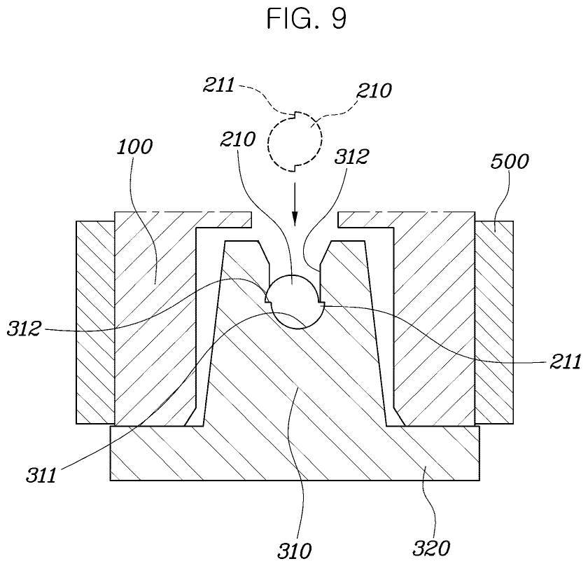

As shown in FIG. 9, in the locker 210 and the holder 310 according to the other embodiment of the present disclosure, the jaw 211 may be formed in plural at the periphery of the locker 210 about the center portion of the cross-section of the locker 210 so that the plurality of jaws 211 is asymmetrically disposed with reference to the center portion of the cross-section, and the engagement jaw 312 may also be formed in plural so that the plurality of engagement jaws 312 is asymmetrically disposed with reference to the insertion direction of the locker 210 while protruding.

That is, a plurality of jaws 211 may be formed at a peripheral surface of the locker 210 so that corresponding ones of the plurality of jaws 211 oppose each other. Each jaw 211 may include a step configured to be engaged with the engagement jaw 312. The corresponding jaws 211 may be asymmetrically formed so that the steps thereof have reversed shapes, respectively.

Furthermore, a plurality of engagement jaws 312 configured to allow respective jaws 211 of the locker 210 to be engaged therewith may be formed at the groove 311 of the holder 310 so that corresponding ones thereof are disposed to face each other. The engagement jaws 312 may protrude asymmetrically to enable the steps of respective jaws 211 to be engaged therewith in accordance with a rotation direction of the locker 210.

In accordance with the above-described configurations, when the part P1 moves to dock with the counterpart P2, the rotation direction of the locker 210 may be adjusted by the driver 200 so that the jaws 211 of the locker 210 face or oppose the groove 311, and, accordingly, the locker 210 may be inserted into the groove 311 formed at the holder 310 of the counterpart P2. When the locker 210 is inserted into the groove 311 to reach the internal end portion of the groove 311, the locker 210 is then rotated by the driver 200 so that each jaw 211 of the locker 210 comes into contact with a corresponding one of the engagement jaws 312 of the groove 311. Accordingly, the locker 210 may be locked by the holder 310.

Thus, the part P1 and the counterpart P2 may be in a joined state in accordance with mechanical connection through the locker 210 and the holder 310.

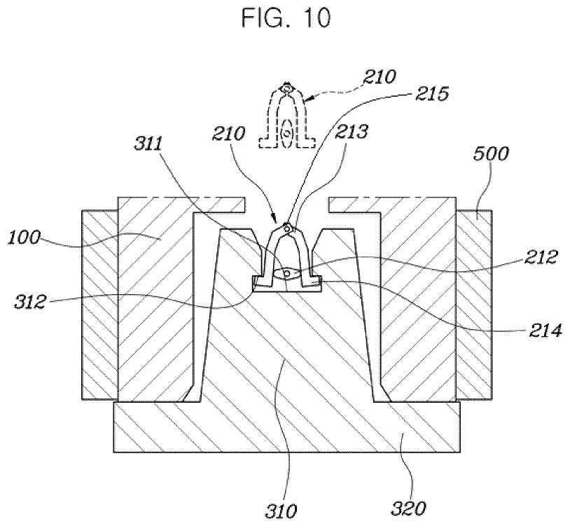

Meanwhile, in another exemplary embodiment of the present disclosure, as shown in FIG. 10, the locker 210 may include a rotation member 212 configured to be rotated by the driver 200, and an engagement member 213 configured to be deformed by the rotation member 212 in accordance with rotation of the rotation member 212, being selectively engaged with the engagement jaws 312.

The rotation member 212 may be mounted at the opening 110, and may be connected to the driver 200 so that the rotation member 212 rotates by drive power received from the driver 200. The engagement member 213 may be mounted at the body 100 within the opening 110, and may be configured to be deformed in accordance with a rotation direction of the rotation member 212 in a state of contacting with the rotation member 212.

In detail, the rotation member 212 includes a cross-section having a non-circular shape or a polygonal shape, and the engagement member 213 includes a pair of hooks 214 rotatably connected to each other. As rotation member 212 is disposed between the pair of hooks 214, the pair of hooks 214 may be diverged or converged in accordance with a rotation direction of the rotation member 212, and accordingly, may be selectively engaged with the engagement jaws 312.

In an exemplary embodiment of the present disclosure, the rotation member 212 may be formed to have an oval shape. The engagement member 213 may include the pair of hooks 214, and the hooks 214 may be rotatably connected to each other at one-side end portions thereof by a hinge pin 215. The hinge pin 215 may be fixed to the body 100.

Furthermore, each hook 214 of the engagement member 213 may be formed to have a bent shape at the other-side end portion thereof so that the other-side end portion of the hook 214 is engaged with the engagement jaw 312.

Furthermore, as the rotation member 212 is disposed between the pair of hooks 214 forming the engagement member 213, the pair of hooks 214 may be diverged or converged along a contact surface of the rotation member 212 including an oval shape when the rotation member 212 rotates.

When the part P1 moves to dock with the counterpart P2, the oval rotation member 212 is adjusted to be erected by the driver 200. Accordingly, the pair of hooks 214 forming the engagement member 213 is converged, and, accordingly, the locker 210 may be inserted into the groove 311 formed at the holder 310. When the locker 210 is inserted into the groove 311 to reach the internal end portion of the groove 311, the rotation member 212 is then rotated to be reclined by the driver 200, and, accordingly, the pair of hooks 214 forming the engagement member 213 is diverged by the rotation member 212 to enable the hooks 214 to be engaged with respective engagement jaws 312. Thus, the part P1 and the counterpart P2 may be in a joined state in accordance with mechanical connection through the locker 210 and the holder 310.

Meanwhile, as shown in FIG. 6, the magnetic member 400 may include a first magnet 410 and a second magnet 420. The first magnet 410 may be connected to the driver 200 within the body 100 so that the first magnet 410 is rotatable, and the second magnet 420 may be fixed within the body 100 while being spaced apart from the first magnet 410.

Each of the first magnet 410 and the second magnet 420 described above may include a permanent magnet, and, accordingly, the direction of magnetic field lines flowing through the body 100 may be varied in accordance with a rotation direction of the first magnet 410.

For joining between the body 100 of the part P1 and the counterpart P2, magnetic force may be used. Through magnetic flows of the first magnet 410 and the second magnet 420 each including a permanent magnet, the body 100 of the part P1 may be magnetically joined to the counterpart P2.

As the first magnet 410, which is connected to the driver 200, rotates within the body 100, directions of an N-pole and an S-pole of the first magnet 410 contacting with the body 100 may be changed. Since the second magnet 420 is fixed to the body 100, positions of an N-pole and an S-pole of the second magnet 420 may be fixed.

Referring to FIG. 6, when respective polarities of the first magnet 410 are disposed to cross respective polarities of the second magnet 420 in accordance with rotation of the first magnet 410 in the above-described configuration, magnetic flows may be formed only at the first magnet 410 and the second magnet 420 via the body 100. Accordingly, even when the body 100 comes into contact with the counterpart P2, the body 100 may not be joined to the counterpart P2.

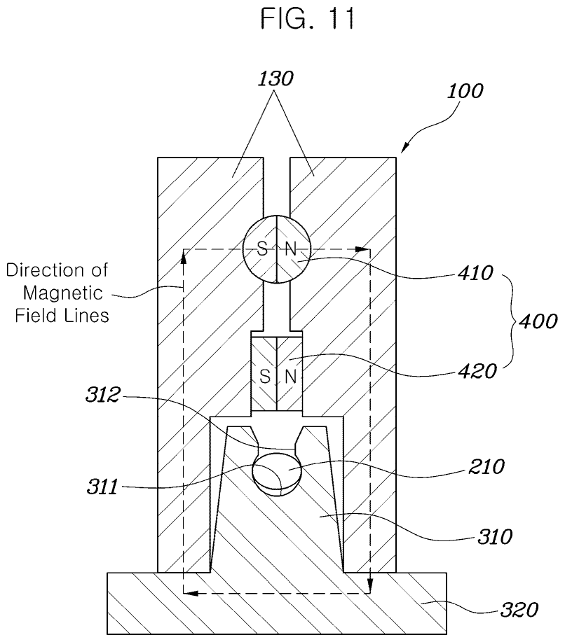

When the first magnet 410 rotates so that respective polarities of the first magnet 410 match with respective polarities of the second magnet 420, as shown in FIG. 11, a magnetic field may be formed in a direction in which the magnetic field extends to the counterpart P2 through the body 100. Accordingly, the body 100 and the counterpart P2 may be magnetically joined.

The joining state between the body 100 of the part P1 and the counterpart P2 may be achieved through change of the rotation direction of the first magnet 410 according to operation of the driver 200. That is, in an exemplary embodiment of the present disclosure, the joining state between the part P1 and the counterpart P2 may be switched through the first magnet 410 and the second magnet 420, and may be maintained even when the driver 200 is not driven, when polarities of the first magnet 410 and the second magnet 420 are matched. Accordingly, consumption of electric power for maintenance of docking may be reduced.

The above-described rotation operation of the locker 210 and the above-described rotation operation of the first magnet 410 may be achieved through a configuration in which separate drivers 200 are provided for the locker 210 and the first magnet 410, respectively, or a configuration in which the locker 210 and the first magnet 410 are connected to one driver 200 in common.

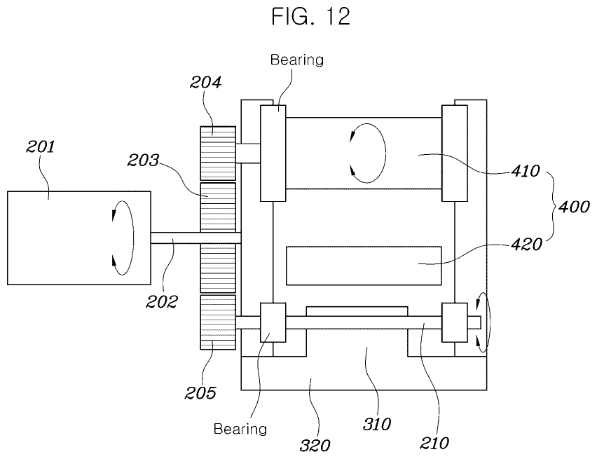

For example, as shown in FIG. 12, the driver 200 may include a motor 201 including a shaft 202 configured to be rotated by rotation force, a drive gear 203 coupled to the shaft 202, a first driven gear 204 engaged with the drive gear 203 while being connected to the first magnet 410, and a second driven gear 205 engaged with the drive gear 203 while being connected to the locker 210.

As described above, the driver 200 may include the motor 201, the drive gear 203, the first driven gear 204, and the second driven gear 205, and accordingly, locking through magnetic force of the first magnet 410 and mechanical locking of the locker 210 may be simultaneously achieved using one motor 201.

The motor 201 includes the shaft 202, and generates rotation force, rotating the shaft 202. Operation of the motor 201 may be controlled by a controller operatively connected to the motor 201.

The drive gear 203 is coupled to the shaft 202 to rotate together with the shaft 202. The first driven gear 204 and the second driven gear 205 are engaged with the drive gear 203 around the drive gear 203. The first magnet 410 is connected to the first driven gear 204, and the locker 210 is connected to the second driven gear 205. Accordingly, as the first driven gear 204 and the second driven gear 205 are simultaneously rotated by rotation force of the motor 201, magnetic connection by the magnetic member 400 and mechanical connection of the locker 210 may be simultaneously conducted. Identically, the magnetic connection by the magnetic member 400 and the mechanical connection of the locker 210 may be simultaneously released through rotation of the gears by the motor 201.

Meanwhile, the counterpart P2 may include a joint 320, and a holder 310 extending from the joint 320. The joint 320 may be made of a magnetic material, and may be formed to enable the body 100 of the part P1 to be joined thereto. The holder 310 may be formed to extend from the joint 320 so that the holder 310 is insertable into the opening 110.

Referring to FIG. 6, the counterpart P2 may include a joint 320 and a holder 310. The joint 320 may be formed to enable the body 100 of the part P1 to be seated thereon while coming into contact therewith. The holder 310 may be formed to extend from the joint 320 toward the opening 110 of the body 100 so that the holder 310 is insertable into the opening 110.

Accordingly, when the part P1 and the counterpart P2 dock with each other, the body 100 of the part P1 may be joined to the joint 320 of the counterpart P2 by magnetic force of the magnetic member 400 in a state of contacting with the joint 320 of the counterpart P2. To the present end, the counterpart P2 may be made of a magnetic material. For manufacture of the counterpart P2 as described above, metal powder forming a magnetic material may be produced and may then be mixed, the mixed powder may be compressively molded to form the counterpart P2, and the compressively molded counterpart P2 may be subjected to thermal treatment to have enhanced molding density and characteristics. In the instant case, for the metal powder for manufacture of the counterpart P2, an Si—Fe alloy powder material may be used. Accordingly, it may be possible to produce a magnetic material under the condition that no rare earth elements are included in the magnetic material, and accordingly, a magnetic material configured for enhancing magnetic force while having corrosion resistance may be produced. Accordingly, a magnetic material exhibiting an enhancement in magnetic characteristics such as coercivity or the like without damage to corrosion resistance thereof may be produced.

Meanwhile, the holder 310 has a width gradually decreasing as the holder 310 extends toward the part P1 so that an external surface thereof is formed to be inclined.

As the external surface of the holder 310 is formed to be inclined, the inclined external surface functions as a guide when the holder 310 is inserted into the opening 110 of the body 110. Accordingly, the holder 310 may be smoothly inserted into the opening 110 and may be guided to a position where the part P1 and the counterpart P2 can dock with each other.

Meanwhile, as shown in FIG. 8, the part P1 may be further provided with a damper 500 disposed around the body 100. The damper 500 may be made of a rubber material or may be made of various materials, so long as the materials can absorb impact.

As the damper 500 is provided around the body 100 at the part P1, vibrations transmitted to the part P1 in a state in which the part P1 is provided at an object may be absorbed. Although the body 100 is magnetized by the magnetic member 400 provided within the body 100, the damper 500 insulates surroundings of the body 100 from magnetic energy. The damper 500 may be formed to enclose the entirety of the part P1 or to enclose only the body 100.

Meanwhile, in an exemplary embodiment of the present disclosure, the docking apparatus may further include a guide 600 spaced apart from the part P1, and an inserter 700 spaced apart from the counterpart P2.

The guide 600 and the inserter 700 may be configured so that the inserter 700 is insertable into the guide 600 in a direction in which the part P1 and the counterpart P2 come into contact with each other.

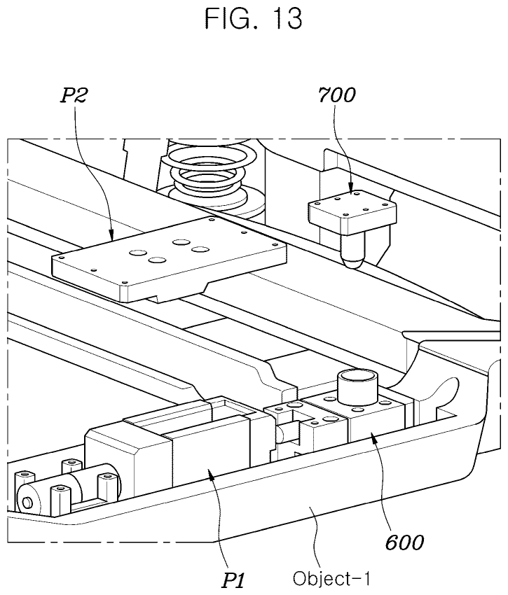

As shown in FIG. 13, the guide 600 may be provided in an area where the part P1 is provided, together with the part P1, and the inserter 700 may be provided in an area where the counterpart P2 is provided, together with the counterpart P2.

The guide 600 and the inserter 700 may have structures insertable into each other, respectively. For example, the guide 600 may be formed with a groove and the inserter 700 may be formed with a protrusion so that the protrusion is insertable into the groove.

As the guide 600 and the inserter 700 are further provided, the part P1 and the counterpart P2 may be guided in a docking direction in which the part P1 and the counterpart P2 dock with each other, through the insertion structures of the guide 600 and the inserter 700. Furthermore, as the guide 600 and the inserter 700 are interconnected through insertion, it may be possible to reduce tolerance between objects to dock with each other. Furthermore, structural stability may be achieved after completion of docking.

In accordance with the docking apparatus of the present disclosure, when different parts dock with each other, a strong docking state may be maintained in accordance with linkage of locking according to magnetism and locking according to mechanical connection. Furthermore, generation of gaps in various directions including upward, downward, left and right directions may be prevented in the docking state, and accordingly, durability and quality of each part may be secured.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code that may be executed by a computer using an interpreter or the like. Furthermore, the computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in the present disclosure should be interpreted as indicating “additionally or alternatively.” The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A docking system comprising:
a first part including a body and a driver, wherein the body is provided with a magnetic member formed of a magnetic material to be magnetized by the magnetic member and including an opening extending in one direction, and wherein the driver includes a locker configured to vary a rotation direction thereof and disposed at the opening; and
a second part including a holder configured to be inserted into the opening of the first portion while extending toward the opening and being configured to receive the locker therein,
wherein the second part is joined to the first part by magnetic force based on that the second part comes into contact with the first portion, and
wherein the locker is engaged with the holder in accordance with the rotation direction of the locker according to operation of the driver so that the locker is locked by the holder.

2. The docking system of claim 1,
wherein the body includes a first portion made of the magnetic material, and a second portion made of a non-magnetic material, and
wherein the opening is formed at the first portion, the driver is provided at the second portion, and the locker of the driver is disposed at the opening while extending through the first portion and the second portion.

3. The docking system of claim 2, wherein an installation portion is formed at an inside of the first portion to communicate with the opening, and the magnetic member is installed at the installation portion.

4. The docking system of claim 2,
wherein the first portion is provided at a center portion of the body,
wherein the second portion includes two second portions coupled to opposite sides of the first portion, respectively so that the driver is installed at one of the two second portions, and
wherein the locker extending from the driver is rotatably supported by another of the two second portions.

5. The docking system of claim 1, wherein the holder includes a groove configured to receive the locker and engagement jaws are formed at the groove so that the locker is engaged with the engagement jaws in accordance with a rotation direction of the locker, to be locked.

6. The docking system of claim 5, wherein the groove is formed at a center portion of the holder, and the engagement jaws are formed to be symmetrical with each other with reference to a center portion of the groove.

7. The docking system of claim 5,
wherein a cross-section of the locker in a direction in which the first part and the second part come into contact with each other has an oval shape, and
wherein the holder is formed so that a portion of the groove, at which the engagement jaws are formed, has an internal diameter greater than or equal to a length of a shorter width portion of the oval shape of the locker, and an internal end portion of the groove is formed to have a circular shape having an internal diameter greater than a length of a longer width portion of the oval shape of the locker.

8. The docking system of claim 5, wherein the locker is formed so that a cross-section of the locker in a direction in which the first part and the second part come into contact with each other has a circular shape, and is formed with at least one jaw at a periphery of the locker.

9. The docking system of claim 8,
wherein the at least one jaw is formed in plural at the periphery of the locker about a center portion of the cross-section of the locker so that the plurality of jaws is asymmetrically disposed with reference to the center portion of the cross-section, and
wherein the engagement jaw is formed in plural so that the plurality of engagement jaws is asymmetrically disposed with reference to an insertion direction of the locker while protruding.

10. The docking system of claim 5, wherein the locker includes:
a rotation member coupled to the driver and configured to be rotated by the driver; and
an engagement member configured to be deformed by the rotation member in accordance with rotation of the rotation member, being selectively engaged with the engagement jaws.

11. The docking system of claim 10,
wherein the rotation member has a cross-section having a non-circular shape or a polygonal shape,
wherein the engagement member includes a pair of hooks rotatably connected to each other, and
wherein the rotation member is disposed between the pair of hooks to diverge or converge the pair of hooks in accordance with a rotation direction of the rotation member, causing the pair of hooks to be selectively engaged with the engagement jaws.

12. The docking system of claim 1,
wherein the magnetic member includes a first magnet and a second magnet, and
wherein the first magnet is coupled to the driver and rotatably mounted to the body so that the first magnet is rotatable according to operation of the driver, and
wherein the second magnet is spaced apart from the first magnet and fixed within the body.

13. The docking system of claim 12, wherein each of the first magnet and the second magnet includes a permanent magnet so that a direction of magnetic field lines flowing through the body is varied in accordance with a rotation direction of the first magnet.

14. The docking system of claim 12, wherein the driver further include:
a motor including a shaft;
a drive gear connected to the shaft;
a first driven gear connected to the first magnet and engaged with the drive gear; and
a second driven gear connected to the locker and engaged with the drive gear.

15. The docking system of claim 1,
wherein the second part further includes a joint from which the holder extends,
wherein the joint is made of a magnetic material and is formed to enable the body of the first part to be joined thereto, and
wherein the holder is formed to extend from the joint so that the holder is selectively inserted into the opening.

16. The docking system of claim 1, wherein the holder includes a width decreasing as the holder extends toward the first part so that an external surface of the holder is formed to be inclined.

17. The docking system of claim 1, wherein the first part further includes a damper disposed around the body.

18. The docking system of claim 1, further including:
a guide spaced apart from the first part; and
an inserter spaced apart from the second part,
wherein the guide and the inserter are configured so that the inserter is insertable into the guide in a direction in which the first part and the second part come into contact with each other.
